(19) United States
(12) Patent Application Publication
(10) Pub. No.: US 2009/0004083 A1
(43) Pub. Date: Jan. 1, 2009

(54) NOx control for IC engines

(76) Inventors: James M. Valentine, Fairfield, CT (US); Jeremy D. Peter-Hoblyn, Cornwall (GB); John E. Hofmann, Watchung, NJ (US)

Correspondence Address: THADDIUS J. CARVIS, 102 NORTH KING STREET, LEESBURG, VA, 20176, US

(21) Appl. No.: 10/536,170

(22) Filed: Jun. 17, 2005

Related U.S. Application Data
(63) Continuation of application No. PCT/US2003/040263, filed on Dec. 17, 2003.

(51) Int. Cl. B01D 53/56

(52) U.S. Cl. 423/239.2; 423/239.1

(57) ABSTRACT

A multi-stage NOx reduction system employs catalysts effective at different temperature ranges and can have reagent injectors associated with each, for use in series or in parallel. A controller directs reagent introduction to one catalyst or the other as temperature and other conditions dictate. Valving can redirect exhaust to particular catalyst zones, if necessary.

### BACKGROUND OF THE INVENTION

The invention concerns a new device and process for reducing NOₓ emissions, particularly for mobile diesel and other lean-burn engines.

Internal combustion engines, particularly non-spark ignited (diesel) engines, are desirable because of their energy efficiency. Diesel and lean-burn gasoline engines provide particular advantages in fuel economy and are favored for this reason. However, they tend to produce high concentrations of nitrogen oxides (NOₓ) in the combustion gas because of the high temperature involved in the combustion process. Efforts to reduce the combustion temperature, by water injection, exhaust gas recycle or the like, can be successful, but tend to increase the emission of other undesirable components, particularly carbon monoxide and products of incomplete combustion.

Emissions of NOₓ can also be reduced by post-combustion techniques. A particularly good example of such techniques is selective catalytic reduction (SCR). In the SCR process, NOₓ is reacted with NH₃, or similar nitrogen containing compounds such as urea and like materials, over a catalyst to yield nitrogen gas (N₂) and water (H₂O). There are many catalysts that have been described in the literature but each catalyst tends to have a relative narrow temperature range over the catalyst is effective. Such behavior has been described in detail by R. M. Heck, I. M. Chen and B. K. Speronello of the Engelhard Corporation. In “Operating Characteristics and Conunercial Operating Experience with High Temperature SCR NOₓ Catalyst”, Environmental Progress, Vol. 13, No. 4, pp. 221-225.

The exhaust gas from a typical diesel engine can have a gas temperature that ranges from about 150° C. all the way up to 600° C. and perhaps even higher. This range arises from variations in the engine load with increasing load resulting in higher gas temperatures. No single catalyst has been found to be effective over this entire temperature range. Thus, NOₓ reduction has been limited for engines that operate under transient conditions wherein exhaust gas temperature can very over the entire range.

Despite the availability of devices and systems of the type described there remains a current need for an economical and effective answer to the problems associated with reducing NOₓ, particularly for mobile diesel and other lean-burn engines.

### SUMMARY OF THE INVENTION

The invention provides a new device and a new process addressing the above needs.

A multi-stage NOₓ reduction system employs catalysts effective at different temperature ranges and has reagent injectors associated with each or a means for directing reagent to each. A controller moves reagent introduction from one catalyst to the other as temperature and other conditions dictate. Valving could redirect exhaust to particular catalyst zones, if necessary.

Many of the preferred aspects of the invention are described below. Equivalent structures, procedures and compositions are contemplated.

### DESCRIPTION OF THE DRAWINGS

The invention will be better understood and its advantages will be more apparent when the following detailed description is read in light of the accompanying drawings, wherein:

FIG. 1 is a schematic view of one embodiment of the invention; and

FIG. 2 is a schematic view of another embodiment of the invention.

### DESCRIPTION OF THE INVENTION

As noted above, the invention relates to a new device and a new process addressing the above needs and is intended for use with diesel engines, but has applicability to any combustors having similar wide variations in exhaust gas temperatures, such as turbines, boilers, furnaces, process heaters, heat recovery units, and the like, utilizing carbonaceous, e.g., fossil or bio-derived, fuels such as distillates, residual and gaseous fuels.

It has now been found that the overall performance of the SCR process for diesel engines can be improved by utilizing two, or more, catalysts in series or in parallel where the reagent for NOx reduction (NH₃, urea or the like) is selectively injected to take advantage of the appropriate operating range for each catalyst. NOₓ-reducing reagent can, for example, be selected from the group consisting of ammelide, ammeline, ammonia, ammonium carbonate, ammonium bicarbonate, ammonium carbamate, ammonium cyanate, ammonium salts of inorganic acids, ammonium salts of organic acids, biuret, cyanuric acid, hexamethylenetetramine, isocyanic acid, lower alkyl amines, melamine, tricyanourea and urea.

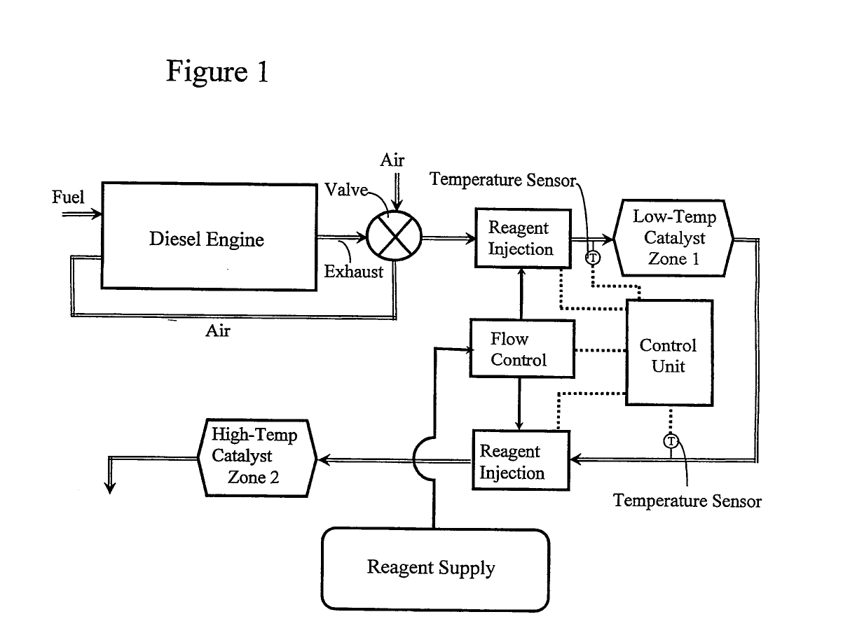

Referring to FIG. 1, a diesel engine is fitted with two catalysts in series in the exhaust gas. Means for introducing the reagent for NO, reduction are provided at points upstream of each catalyst zone. The first catalyst (Low-Temp Catalyst Zone 1) could be of the LT-1 or LT-2 types as described in the above-cited paper by Heck, et al. The second catalyst (High-Temp Catalyst Zone 2) could be of the VNX or ZNX type as described by Heck, et al. When the engine is operating under lower load conditions and the exhaust gas temperature is low, say in the range of 200-250° C., the NOₓ reducing agent would be injected upstream of catalyst zone 1. Reduction in NO, emissions would be achieved over catalyst zone 1 and there would be little if any further reaction over catalyst 2. When the engine is operating at higher load conditions, with higher gas temperatures, the continued injection of NOₓ reducing reagent (e.g., NH₃ or the like) upstream of catalyst can actually result in the formation of NOₓ arising from the oxidation of NH₃. An automatic control including a temperature sensor to detect the gas temperature, switches the location of reagent injection from catalyst zone 1 to catalyst zone 2. Following the switch, reduction of NO, is achieved over catalyst 2 that is effective for NOx reduction at a higher temperature, say in the range of 300-450° C.

There is a further benefit to the proposed system. Most of the emissions of NOₓ from diesel engines is in the form of nitrogen monoxide (NO). However, it has been found that nitrogen dioxide (NO₂) tends to react more rapidly over a typical SCR catalyst. Catalyst 1 typically will promote oxidation reactions when the temperature exceeds the normal operating window for SCR. Thus, for catalysts of the LT-1 or LT-2 types, oxidation of the NOₓ reducing reagent (e.g., NH₃) becomes a problem when the temperature exceeds 250-300° C., thus necessitating the switch in injection points from zone I to zone 2. Catalyst 1 retains its property to promote oxidation at the higher temperature and this can yield several benefits. Carbon monoxide (CO) will be oxidized to CO₂. Unreacted hydrocarbons will be converted to CO₂. Finally, NO will tend to be converted to NO₂. In this mode of operation, the exhaust gas containing NOₓ, mostly as NO₂, will be passed through the zone 2 catalyst to achieve higher than normal NOₓ reduction.

In yet another variation of the basic series set up of FIG. 1, the reagent will be introduced into both the first and second zones. In this embodiment, the utilization of reagent can be controlled to a highly efficient extent. Because reagent can be almost as expensive as fuel, this is a particularly advantageous embodiment, and the controller will take measured parameters and compare them to reference values to create control signals that can optimize reagent and fuel utilization while maximizing NOₓ reduction. If desired, feed back control can help assure maintenance of target values.

The NO₂ formed in catalyst zone 1 will tend to react more rapidly with the NOₓ reducing reagent (NH₃) in catalyst zone 2. Thus, the efficiency of catalyst 2 will be improved because of the more reactive species involved in the reaction:

4NH₃+4NO+O₂=4N₂+6H₂O (fast)

6NH₃+4NO₂+1/2O2=5N₂+9H₂O (faster)

It should be noted that the same advantages can be achieved by putting three or more catalysts in series and changing the point of reagent injection to follow the optimum performance curve for each individual catalyst. The number of catalysts to be employed will be constrained only by costs and the physical limitations imposed by space within the exhaust system. An ARIS™ injector and injection system, e.g., as described in U.S. Pat. No. 5,976,475 and U.S. Pat. No. 6,279,603, is particularly well suited to be employed in the multiple catalyst system because of their small in size, an ability to operate without any secondary medium for atomization, such as air and it can be close-coupled to the catalyst zone. The control unit can also receive other control inputs as described in the above patents, which are incorporated herein by reference, and can control the fuel and air supply to the engine, and can control exhaust gas recirculation, EGR, as useful for NOₓ control and fuel economy as described in U.S. Pat. No. 5,924,280.

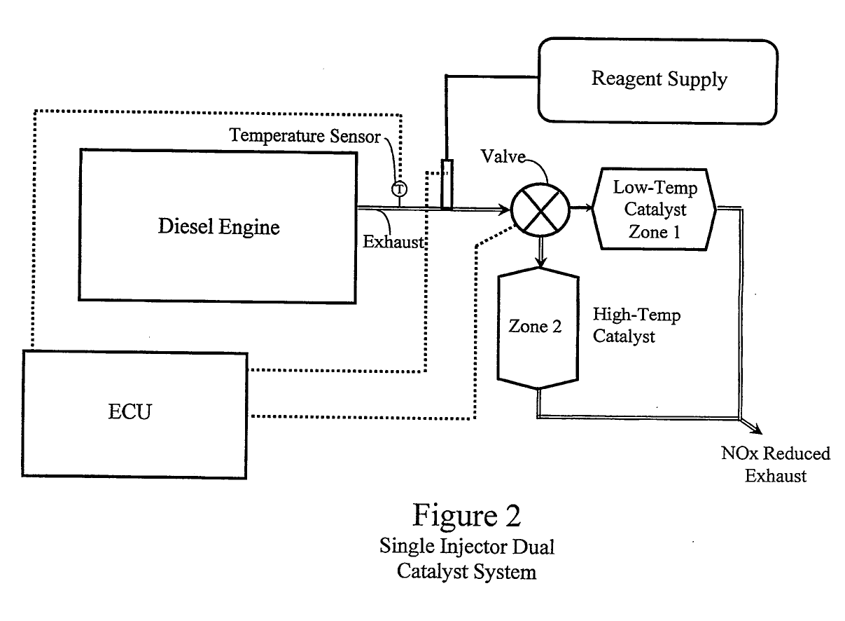

FIG. 2 describes another embodiment, wherein a diesel engine exhaust is passed through a valve which directs exhaust gas flow to either low temperature catalyst No. 1 of the precious metal or base metal (vanadium/titanium type) during low exhaust gas temperatures (350° F.-800° F.) such as described in SAE 2001-01-0519; or to high temperature catalyst No. 2, typically of the zeolite type, for temperatures of 675° F. to 1100° F., based on an input from a temperature sensor in the exhaust stream upstream of the exhaust gas valve.

Valves such as those used with exhaust gas recirculation are known to be able to operate in this environment. Temperature signals are fed to an engine control unit (ECU) or other suitable controller, which controls the valve to regulate the flow of exhaust gas between catalyst 1 or catalyst 2 based on exhaust gas temp or an engine signal, such as load, speed or rpm, as a predictor of exhaust gas temperature. Urea or other NOₓ reducing reagent is injected upstream of the valve for single injector systems or downstream of the valve but upstream of each separate catalyst zone for dual injector systems. In single or dual injector systems the valve can regulate exhaust gas flow, and reagent injection rate is controlled to maximize NOₓ reduction across either catalyst No, or catalyst No. 2 or both in combination by regulating exhaust gas flow and injector feed rate of reagent.

The above description is intended to enable the person skilled in the art to practice the invention. All of the references cited above are hereby incorporated by reference in their entireties to show and describe the points illustrated herein, and should be taken as if fully and bodily incorporated. It is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

1. A method for reducing the NOₓ content of combustion exhaust comprising:
passing combustion gases through a multi-zone NOₓ reduction catalytic treatment system, wherein reagent for NOₓ reduction is introduced by means provided at least one point upstream of each catalyst zone.

2. A process according to claim 1 wherein a first catalyst zone is of the LT-1 or LT-2 type and a second stage catalyst is of the VNX or ZNX type.

3. A process according to claim 1 wherein, when the engine is operating under lower load conditions and the exhaust gas temperature is low, the NOₓ reducing agent is injected upstream of catalyst zone 1, whereby reduction in NOₓ emissions would be achieved over catalyst 1 and there would be little if any further reaction over catalyst 2.

4. A process according to claim 1 wherein, when the engine is operating at high load conditions, with relatively high gas temperatures, the continued injection of NOₓ reducing reagent upstream of catalyst 1 is avoided where it can actually result in the formation of NOₓ arising from the oxidation of the reagent and injection takes place in front of catalyst 2.

5. A process according to claim 1 wherein, an automatic sensor, based on gas temperature, provides a signal to a controller, which switches the location of reagent injection from zone 1 to zone 2 and reduction of NOₓ is achieved over catalyst 1 or 2 whichever is most effective for NOₓ reduction.

6. A process according to claim 1 wherein the gases are passed through a valve which directs exhaust gas flow to either low temperature catalyst No. 1 of the precious metal or base metal (e.g., vanadium/titanium) type during low exhaust gas temperatures (e.g., 350° F.-800° F.) such as described in SAE 2001-01-0519; or to high temperature catalyst No. 2, typically of the zeolite type, for high temperatures (e.g., of 675° F. to 1100° F.) based on an input from a temperature sensor in the exhaust stream upstream of the exhaust gas valve.

7. A process according to claim 1 wherein reagent flow is done by one injector upstream of exhaust gas flow valve or after said valve but in front of each separate catalyst using two injectors one positioned in front of each catalyst.

8. A process according to claim 1 wherein exhaust gas flow is split between catalyst 1 and catalyst 2 for at least some portion of the engine operating cycle and reagent is injected upstream of each catalyst using a single injector upstream of the exhaust flow control valve or separate injectors in front of each catalyst.
